(19) United States
(12) Patent Application Publication
(10) Pub. No.: US 2018/0324063 A1
(43) Pub. Date: Nov. 8, 2018

(54) CLOUD-BASED SYSTEM FOR DEVICE MONITORING AND CONTROL

(71) Applicant: Finderscopus, Inc., Cupertino, CA (US)

(72) Inventor: Henrique G. OLIVEIRA, San Ramon, CA (US)

(21) Appl. No.: 15/968,707

(22) Filed: May 1, 2018

Related U.S. Application Data
(60) Provisional application No. 62/500,463, filed on May 2, 2017.

(51) Int. Cl. H04L 12/26; H04L 12/24

(52) U.S. Cl. CPC H04L 43/04; H04L 43/08; H04L 41/0213; H04L 41/0853; H04L 41/06; H04L 43/16

(57) ABSTRACT

A stateless cloud-enabled data collection system is disclosed. The cloud-enabled data collection system collects data from local devices on a network, such as a TCP/IP network. The cloud-enabled data collection system receives configuration from a cloud-based monitoring system on a cloud. Based on the configuration, the cloud-enabled data collection system collects data from local devices. The data is pre-processed for communication with the cloud-based monitoring system and to determine if the data is out-of-range based on the configuration.

### CROSS-REFERENCE TO RELATED APPLICATIONS

This application claims the priority benefits of U.S. Provisional Application Ser. No. 62/500,463, filed on May 2, 2017, entitled “A Stateless Cloud-Based System For Device Monitoring And Control”, which is incorporated by reference in their entirety for all purposes.

### TECHNICAL FIELD

This disclosure relates to the field of monitoring and controlling devices on a computer network. More particularly, the disclosure relates to devices and methods for monitoring and controlling devices on a computer network, such as a TCP/IP computer network, that respond to polling commands such as SNMP, IPMI, Modbus, as well as other polling commands.

### BACKGROUND

Computer networks, such as TCP/IP networks, have experienced tremendous growth in the last decades, spurred on by the digitalization of all aspects of our lives including our businesses, homes, healthcare facilities, and industrial plants. This growth has spawned an increasing number of TCP/IP networks as well as the number of devices that are connected to a TCP/IP network. At its early adoption in the 1980's, TCP/IP networks were used primarily to create a network of computers. Today, TCP/IP networks are used to connect numerous other types of devices besides computers, such as telephones, televisions, printers, cellular phones, security cameras, telemetry sensors. Analysts predict that the number of connected devices will reach 75 billion by 2025.

With the explosion of networks and ever-increasing reliance on connected devices by businesses, “downtime events” can significantly negatively impact revenues. A downtime event, for example, may be a failure to respond or an unsatisfactory response by a connected device or service. To decrease the occurrence of “downtime events”, systems for monitoring devices on computer networks have been employed. Such systems collect data from monitored devices connected to the network. However, existing monitoring systems are inflexible or difficult regarding scalability, both in terms of processing power and storage. Scalability of the system is important for efficiently and effectively monitoring connected devices or services, particularly as the number of connected devices and services and frequency of data collection continue to grow in magnitude.

In view of the foregoing, it is desirable to provide a scalable monitory system for connected devices and services on a network.

### SUMMARY

Embodiments of the present disclosure generally relate to cloud-based systems and methods for device monitoring and controlling. In one embodiment, a stateless cloud-enabled data collection system is disclosed. The stateless cloud-enabled data collection system includes a communication manager unit configured to manage communication between the cloud-enabled data collection system on a private network and a cloud-based monitoring system on a cloud. The system also includes a data collection unit configured to collect monitored data from monitored devices communicatively coupled to the private network. The system also includes a pre-processor unit which pre-processes the monitored data collected from the monitored devices. The pre-processor formats the monitored data for sending to the cloud-based monitoring system by the communication manager unit, and checks the monitored data to determine if the monitored data is out-of-range based on configuration of the data collection unit.

In another embodiment, a method for monitoring monitored devices coupled to a network is disclosed. The method includes configuring a cloud-enabled data collection system coupled to the network. The cloud-enabled data collection system collects monitored data from the monitored devices coupled to the network based on configuration of the cloud-enabled data collection system. The method also includes pre-processing the monitored data. The pre-processing includes checking the monitored data to determine if it is out-of-range based on the configruation of the cloud-enabled data collection system. The pre-processing also includes generating an alarm if the monitored data is out-of-range for sending to a cloud-based monitoring system on a cloud by a communication manager unit of the cloud-enabled data collection system to indicate that the monitored data is out-of-range. The pre-processing also includes formatting the monitored data for sending to the cloud-based monitoring system by the communication manager unit of the cloud-enabled data collection system.

In yet another embodiment, a computer-implemented method for monitoring monitored devices coupled to a network is described. The computer-implemented method includes configuring a cloud-enabled data collection system coupled to the network. The cloud-enabled data collection system collects monitored data from the monitored devices coupled to the network based on configuration of the cloud-enabled data collection system. The method also includes pre-processing the monitored data. The pre-processing includes checking the monitored data to determine if it is out-of-range based on the configruation of the cloud-enabled data collection system. The pre-processing also includes generating an alarm if the monitored data is out-of-range for sending to a cloud-based monitoring system on a cloud by a communication manager unit of the cloud-enabled data collection system to indicate that the monitored data is out-of-range. The pre-processing also includes formatting the monitored data for sending to the cloud-based monitoring system by the communication manager unit of the cloud-enabled data collection system.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are incorporated in and form part of the specification in which like numerals designate like parts, illustrate preferred embodiments of the present disclosure and, together with the description, serve to explain the principles of various embodiments of the present disclosure.

FIG. 1 shows an architecture of an embodiment of a monitoring system;

FIG. 2 shows an embodiment of a data collection module of a monitoring system;

FIG. 3 illustrates an architecture of a worker of a monitoring system;

FIG. 4 shows an embodiment of a data retrieval flow;

FIG. 5 shows an embodiment of a configuration flow; and

FIG. 6 shows exemplary embodiments of configuration objects.

### DETAILED DESCRIPTION

Embodiments of the present disclosure generally relate to monitoring and controlling devices connected to a computer network. For example, a monitoring system monitors devices or services running on devices on a network. The term device may refer to the device or the service running on a device. The system responds to polling commands, such as SNMP, IPMI, Modbus, as well as other types of polling commands.

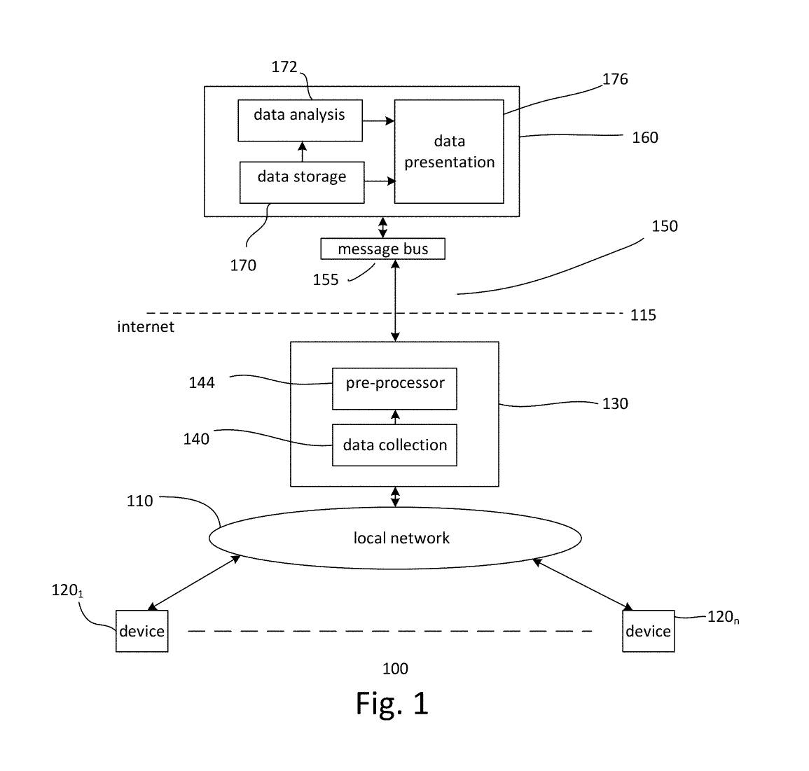

FIG. 1 shows an architecture of an embodiment of a monitoring system 100. In one embodiment, the monitoring system is a cloud-enabled monitoring system. In one embodiment, the monitoring system is a stateless cloud-enabled monitoring system. As shown, the monitoring system includes a monitoring module 130. In one embodiment, the monitoring module is located or deployed in the local network 110. The local network may be a private network, such as a TCP/IP network. Other types of local networks may also be useful. The local network, for example, may include a firewall to prevent unauthorized access.

A plurality of local devices 120₁-120ₙ are monitored by the monitoring system. The local devices monitored by the monitoring system may be referred to as monitored devices. The monitored devices may include devices or services running on the devices. In one embodiment, the monitored devices and monitoring module of the monitoring system are coupled to the local network. For example, the monitored devices and monitoring module interact through the local network.

The monitoring module functions to collect data from the monitored devices it is monitoring. The data collected from the monitored devices may be referred to as monitored data. The monitoring module may include a plurality of different monitoring protocols to obtain monitored data from the monitored devices. In one embodiment, the monitoring protocol is a remote monitoring protocol. The monitoring protocol, for example, may include Simple Network Management Protocol (SNMP), Intelligent Platform Management Interface (IPMI) and Modbus. Other types of monitoring protocols, including future-developed protocols, may also be employed by the monitoring module to collect data from devices. For example, the monitoring module includes a data collection unit which employs monitoring protocols to collect data from monitored devices on the network.

In one embodiment, the monitoring module includes a data collection unit 140 which is communicatively coupled to the monitored devices. Coupled or communicatively coupled may refer to any type of coupling which enables communication or information transfer. The coupling, for example, may be a wired or wireless coupling. The data collection unit 140 collects monitored data from the monitored devices 120₁₋ₙ. The monitored data may include performance metrics of the monitored devices. Various types of performance metrics may be monitored. For example, monitored performance metrics may include, for example, an utilization level of a device or service. Such a performance metric may indicate the percentage of utilization of a device. For example, the monitored data may indicate that a device may be operating at 90% utilization. Other types of performance metrics may also be monitored. For example, monitored performance metrics may include a response time to an instruction. Providing other types of monitored performance metrics or data may also be useful. Different types of monitored devices may have different types of monitored data. For example, different performance metrics may be provided by different monitored devices. In addition, more than one performance metrics may be monitored from a device.

In one embodiment, a baseline performance indicator may be established for a performance metric of a device. The baseline performance indicator may be a set of values reported by the monitored device for a particular performance metric during a calibration period. In the case where multiple performance metrics are measured for a device, multiple baseline performance indicators are established, each corresponding to a performance metric. Each baseline performance indicator may correspond to a particular performance metric. The baseline performance indicator allows the monitoring module to determine if a performance metric for a device is out-of-range based on the baseline performance indicator. For example, the performance metric is compared with the respective baseline performance indicator to determine whether it is out-of-range or not. An out-of-range performance metric may indicate a potential failure.

Upon a detection of an out-of-range performance metric, an alarm or alert may be issued. For example, an alert or alarm is issued by the monitoring module, indicating the affected monitored device and performance metric which is out-of-bounds. The alert or alarm is, for example, sent to a network administrator, indicating the affected monitored device and performance metric which is out-of-bounds. In one embodiment, the alert is sent to the network administrator via the monitoring module on the cloud. Sending the alert by other techniques or processes may also be useful.

In one embodiment, the monitoring module includes a pre-processor unit 144. The pre-processor unit pre-processes the monitored data collected by the data collection unit 140. Pre-processing, in one embodiment, includes determining if the monitored data is out-of-bounds or not. If the monitored data is out-of-bounds, the pre-processing unit generates the alert or alarm.

The monitoring module, as shown, communicates with a data processing module 160 residing on a cloud computing network 150. The cloud computing network may be referred to generally as a cloud. The cloud computing network includes a plurality of interconnected computer systems, such as servers. The servers include processors and memory storage. Generally, the servers of the cloud are proximately located. However, it is understood that other configurations of the servers of the cloud may also be useful. The servers of the cloud act as one, with redundancies in place. The various components of the data processing module may reside in one or more of the servers of the cloud.

The monitoring module 130 may be referred to as a frontend system while the data processing module 160 may be referred to as a backend system. The monitoring module may connect to the cloud via, for example, an internet service 115. The internet service, for example, may be from any internet service provider.

To connect to the cloud, the data monitoring module 130 is coupled to or communicates with a message bus 155 on the cloud. The message bus, for example, may be provided by a cloud service provider, such as Amazon, Google or Microsoft. A cloud service provider may have its own proprietary message bus. The message bus, for example, serves as a gateway for devices to communicate with the cloud securely. The message bus provides encryption and authentication, ensuring secured communications or transactions. The message bus may operate using the Message Queuing Telemetry Transport (MQTT) protocol. Other types of security protocols may also be useful.

The monitored data from the monitoring module 130 on the private network is transmitted to the data processing module 160 on the cloud. In one embodiment, the monitored data, after checking for compliance with baseline performance indicators, is sent to the data processing module on the cloud. The monitored data is stored in a data storage unit 170 of the data processing module. The stored monitored data may be accessed by the data analysis unit 172 of the data processing module. The data analysis unit, for example, may analyze the data to determine possible issues with the network as well as to identify and implement performance improvements. In some embodiments, the data analysis unit applies artificial intelligence and machine learning algorithms to detect hidden patterns and trends. The monitored data and/or the results of the analysis may be presented to a user, such as a network administrator by a data presentation unit 176. As already discussed, the data storage unit, data analysis unit and data presentation unit may be located on the same or different servers of the cloud. In addition, more than one server on the cloud may house each unit.

In one embodiment, the monitoring module 130 does not contain any configuration data except for its identity when the monitoring module is shut down or not operating. For example, the monitoring module includes only the device ID as the configuration data. The monitoring module includes a device ID and a security key. Other types of device configuration data are absent from the data collection module. Upon start-up, the monitoring module 130 connects to the data processing module 160 on the cloud. For example, the monitoring module connects to the data processing module through the message bus 155.

The monitoring module requests configuration data. The requested configuration data changes the behavior of the monitoring module. For example, the monitoring module requests configuration data related to monitoring activity. The configuration data may include various information or data related to monitored data. The configuration data, for example, may include performance metrics which will be monitored or collected from a monitored device, the performance baseline indicators, such as a threshold for alerts and alarms, and polling interval of the monitored data. Other types of configuration data may also be included. During an operation, configuration data may be provided, for example, by the message bus to change the monitoring configuration of the monitoring module. In one embodiment, a network administrator may provide configuration data to change the behavior of the monitoring module.

As previously discussed, different types of monitored data may be collected from different monitored devices. The monitored data, in one embodiment, is based on configuration information. For example, the configuration information indicates the type of performance metric to be collected, including the baseline performance indicator and device ID. The monitoring module may be configured to collect more than one type of monitored data from a device. Other configurations may also be provided for the monitoring module.

As described, the monitoring system may be a remote monitoring solution for networked power distribution units (PDU's) and networked uninterruptible power supplies (UPS's). Other applications for the monitoring system may also be useful. Furthermore, the monitoring solution may be used with existing protocols as well as newly developed protocols. In addition, the monitoring solution may be implemented as software, hardware, such as application specific integrated circuits (ASICs), or a combination thereof.

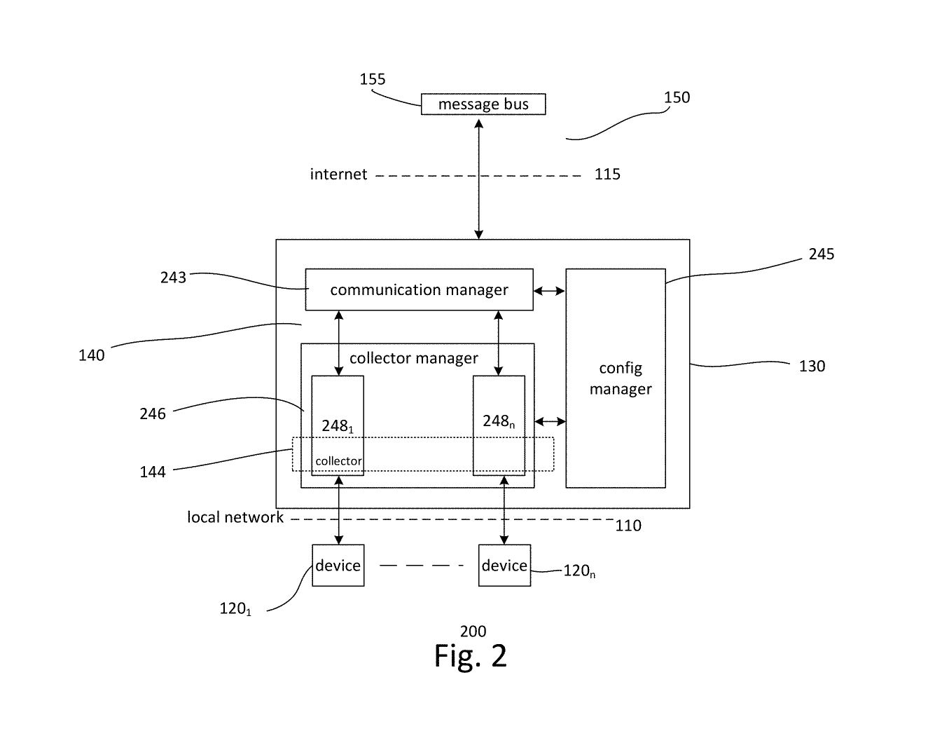

FIG. 2 shows an embodiment of an environment 200 with a frontend system 130. The frontend system is a cloud-enabled data collection system. In one embodiment, the cloud-enabled data collection system is a stateless cloud-enabled data collection system. Other types of cloud-enabled data collection systems may also be useful. The cloud-enabled data collection system, in one embodiment, is coupled to a cloud-based monitoring system (not shown) on a cloud 150. The cloud-enabled data collection system is coupled, as shown, to the cloud via an internet service 115. The cloud-enabled data collection system and cloud-based monitoring system communicate via a message bus 155 on the cloud. The cloud-enabled data collection system is coupled to a plurality of monitored devices 120₁₋ₙ on a network 110. The network may be a private network, such as a TCP/IP network. Other types of networks may also be applicable.

In one embodiment, the cloud-enabled data collection system may be similar to the monitoring module of FIG. 1 and the cloud-based monitoring system may be similar to the data processing module of FIG. 1. In one embodiment, the cloud-based monitoring system may be a software running on the cloud. The cloud-enabled data collection system collects monitored data from the monitored devices. The monitored data is collected based on configuration information. The configuration information may be from the cloud-based monitoring system. The configruation information may be defined by a network adminsitorator and provided to the cloud-enabled data collection system by the cloud-based monitoring system. For example, the configruation information may be provided by the cloud or cloud services to the cloud-enabled data collection system. If the monitored data is out-of-range of performance baseline indicators, the cloud-enabled data collection system generates alerts or alarms, notifying a network administrator of a potential problem or failure of a monitored device on the network. The collected data is forwarded to the cloud-based monitoring system. For example, after checking the monitored data, it is forwarded to the cloud-based monitoring system for storage, analysis and presentation. Utilizing the monitored data for other purposes may also be useful.

The cloud-enabled data collection system 130 may include a data collection module. The data collection module may include a communication manager unit 243, a configuration manager unit 245 and a collector manager unit 246. The collector manager unit, in one embodiment, includes a plurality of collectors. As shown, n collectors 248₁₋ₙ are provided. The number of collectors corresponds to the number of connected monitored devices. For example, each collector is communicatively coupled to a monitored device. The communication may be facilitated by a protocol, such as SNMP, IPMI, or Modbus. The coupling may be wired or wireless coupling. A collector collects monitored data from its designated monitored device. As for the communication manager unit 243, it is communicatively coupled to the cloud-based monitoring system. Furthermore, the various units of the cloud-enabled data collection system are communicatively interconnected. In one embodiment, the communication manager unit 243 is configured to communicate information between the cloud-enabled data collection system and cloud-based monitoring system. For example, the communication manager unit serves as an interface between the cloud-based monitoring system and the cloud-enabled data collection system. In one embodiment, information for and from the collector manager unit and configuration manager unit is via the communication manager unit.

As shown, the communication manager unit is communicatively coupled to the cloud-based monitoring system via the message bus 155. On the other hand, the message bus serves as an interface for the cloud-based monitoring system to communicate with the cloud-enabled data collection system. For example, information to and from the cloud-based monitoring system is via the message bus.

In one embodiment, the configuration manager unit 245 is configured to communicate with the cloud-based monitoring system to receive configuration information and to provide the configuration information to the collector manager unit 246 via the communication manager unit 243. In one embodiment, the configuration manager unit is configured to communicate with the cloud-based monitoring system via the communication manager unit. For example, during start-up of the cloud-enabled data collection system, the configuration manager unit sends a configuration request to the cloud-based monitoring system for configuration information. The configuration request, in one embodiment, is sent to the cloud-based monitoring system via the communication manager unit and message bus. Configuration data may be sent to the configuration manager unit during an operation to change the monitoring behavior of the cloud-enabled system.

Based on the configuration request, configuration data related to monitoring activity is sent from the cloud-based monitoring system to the configuration manager 245 via the message bus 155 and communication manager unit 243. The configuration data is based on the identity of the monitoring system. The configuration data may include various information or data related to monitored data. For example, the configuration data may include performance metrics which will be monitored or collected from a monitored device, including the address of the monitored device, the performance baseline indicator, such as a threshold for alerts and alarms, and polling interval of the monitored data. Other types of configuration data may also be included.

As for the collector manager unit 246, it includes a plurality of collectors 248₁₋ₙ. A collector is configured to monitor a local device. For example, each collector 248ᵢ monitors its respective monitored device 120ᵢ, where i is from 1 to n. The number of n collectors, in one embodiment, is equal to the number of n monitored devices. In one embodiment, the collectors are software collectors. The collectors can be easily created or removed based on needs. For example, collectors can be dynamically created or removed by the collector manager unit based on needs. In other cases, the collectors may be hardware collectors. In such cases, collectors physically are added or removed as needed. Other arrangements of collectors may also be useful.

The configuration manager unit 245 receives configuration data from the cloud-based monitoring system. Based on the configuration data, the configuration manager unit sends operating instructions to the collector manager unit 246. The operating instructions, for example, relate to instructions for configuring a collector to collect monitored data from the monitored device. According to the operating instructions received from the configuration manager unit, the collector manager unit configures the collectors to collect monitored data from the local device.

In one embodiment, the collector manager unit configures one collector at a time. As previously discussed, different collectors can have different configurations. Each collector manager unit is provided with its own configuration. The configuration may be similar except for the device ID. For example, different collectors may be configured to collect the same type of monitored data and include the same type of baseline performance indicator from different monitored devices. Alternatively, different collectors may be configured to collect different types of monitored data. Other arrangements of configurations for the different collectors may also be useful. In one embodiment, configurations are requested for different collectors one at a time. The process of requesting configuration and configuring collectors may be repeated until all collectors are configured. Other approaches for configuring the collectors may also be useful. For example, a configuration request may be issued for all collectors. In such case, the configuration message from the message bus will include multiple configurations for the different collectors. The configuration may include the address of the monitored device that a collector is supposed to monitor as well as the metrics it is supposed to collect from each of the monitored device, and baseline performance indicators. Other configuration information may also be included.

Once configured, collectors 248₁₋ₙ collect monitored data from monitored devices 120ᵢ₋ₙ. Collecting the monitored data may include a remote monitoring protocol. Various types of remote monitoring protocols may be useful. For example, SNMP, IPMI and Modbus protocols may be employed. Other types of monitoring protocols, including future-developed protocols, may also be employed by the monitoring module to collect data from devices.

Monitored data may be pre-processed by the collectors. For example, collectors include a pre-processor unit 144. The pre-processor unit may check the monitored data to determine if it is out-of-range based on performance baseline indicators or performance metrics. Upon a detection of an out-of-range performance metric, an alarm or alert may be issued. For example, an alert or alarm is issued by the monitoring module, indicating the affected monitored device and performance metric which is out-of-bounds. The alert or alarm is, for example, sent to a network administrator, indicating the affected monitored device and performance metric which is out-of-bounds. In one embodiment, the alert or alarm is sent to the cloud-based system via the message bus.

The monitored data from the collectors is transmitted to the cloud-based monitoring system on the cloud. In one embodiment, the monitored data, after checking for compliance with baseline performance indicators, is sent to the monitoring system on the cloud. For example, the collector checks if the monitored data is out-of-range. If the monitored data is out-of-range, it sends an alert to the cloud via the message bus. After checking for out-of-range, the collector sends the monitored data to the cloud for archiving.

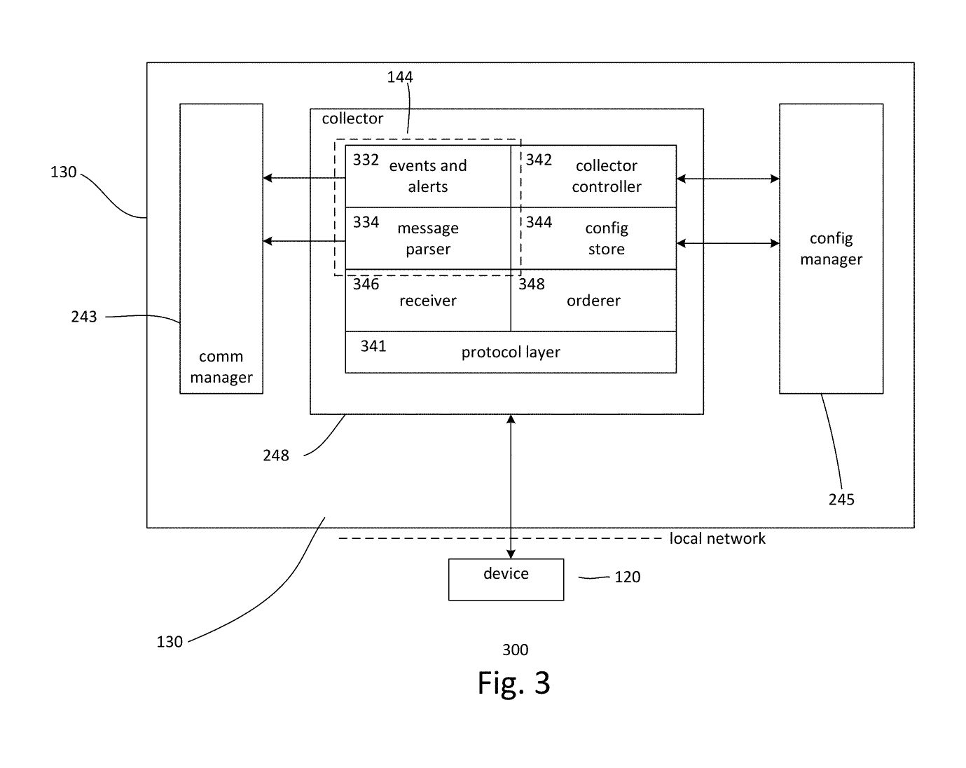

FIG. 3 shows an embodiment of a cloud-enabled data collection system 300 with a collector 248 in greater detail. As shown, the collector 248 of a collector manager unit is communicatively coupled to a communication manager unit 243 and a configuration manager unit 245. The collector manager unit manages the collectors. In one embodiment, the collector manager unit manages configuring the collectors. For example, the configuration manager unit receives configuration data from the cloud-based monitoring system via the message bus. The configuration manager unit informs the collector manager unit to configure the collectors according to the configuration data. In addition, the collector is communicatively coupled to a monitored device 120.

As shown, the collector 248 includes an events and alerts component 332, a message parser component 334, a receiver component 346, a collector controller component 342, a configuration store component 344, an orderer component 348 and a protocol layer component 341. Providing the collector with other components may also be useful. In one embodiment, the events and alerts component and message parser component are part of a pre-processor unit 144 while the other components are part of the data collection unit 140.

In one embodiment, the configuration store component 344 stores the configuration of the collector from the configuration manager unit. For example, the collector manager unit loads the configuration from the configuration manager unit 245 in the configuration store component. The configuration data may include various information or data related to the operation of the collector. For example, the configuration data may include performance metrics which will be monitored or collected from a monitored device, including the address of the monitored device, the performance baseline indicator, such as a threshold for alerts and alarms, and polling interval of the monitored data. Other types of configuration data may also be included.

As for the collector controller component 342, it controls the operation of the collector 248. The collector controller component may control the operation of the collector based on the configuration data in the configuration store component 344. In one embodiment, the collector controller component initiates each iteration of data collection from the monitored device 120 based on polling configuration in the configuration store component. In addition, the collector controller component may receive commands or instructions from the configuration manager unit to pause or resume data collection process. The pause and resume commands may be based on instructions from, for example, the network administrator.

The orderer component 348 issues a command to the monitored device for data collection. For example, the orderer component serves as a command component which issues commands for execution by the monitored device. The command, for example, may be based on the configuration data or instructions received from the cloud-based monitoring system. In one embodiment, the orderer component issues a command to the monitored device in response to an instruction by the collector controller component. The command is issued to the monitored device via the protocol layer component 341. The protocol of the command may depend on the configuration in the configuration store component. For example, an SNMP command may be issued to collect SNMP data or an IPMI command may be issued to collect IPMI data. Other types of protocols may also be useful.

The response to the command from the monitored device is received by the receiver component 346. In one embodiment, the response is received by the receiver component via the protocol layer component 341. The raw data received is pre-processed by the pre-processor unit 144. For example, the raw data is forwarded to the pre-processor unit by the receiver component.

The message parser component 334 of the pre-processor unit transforms the raw data into a communicable format or message with the cloud-based monitoring system. In one embodiment, the raw data of the response is converted to a JavaScript Object Notation (JSON) message. Other types of message formats for communicating with the cloud may also be useful. The message is sent to the communication manager unit 243 for forwarding to the cloud-based monitoring system through the message bus.

The message parser component, in one embodiment, checks the response to detect whether a metric is out-of-range. For example, the message parser component checks the raw data from the monitored device to determine if a metric is out-of-range based on the configuration. The configuration may define out-of-range as beyond a range, within a range, above a threshold value, below a threshold value or not a specific value. Other types of out-of-range configurations may also be useful. After checking, the raw data is converted to a JSON message and sent to the cloud-based monitoring system via the communication manager unit 243 and message bus.

In the event where a metric is detected to be out-of-range, the message parser component 334 generates an alert or alarm message. The alert message, for example, includes the device ID and the metric which is out-of-range. The alert message may also include the value of the metric that may have triggered the alert, the threshold that may have been crossed, and the timestamp. Other types of information may also be included in the alert message. The alert message is forwarded to the events and alerts component 332. The event and alerts component 332 formats the alert message. The alert message is sent to the cloud-based monitoring system through the communication manager unit 243 and the message bus 155. In one embodiment, the alert message is a JSON message.

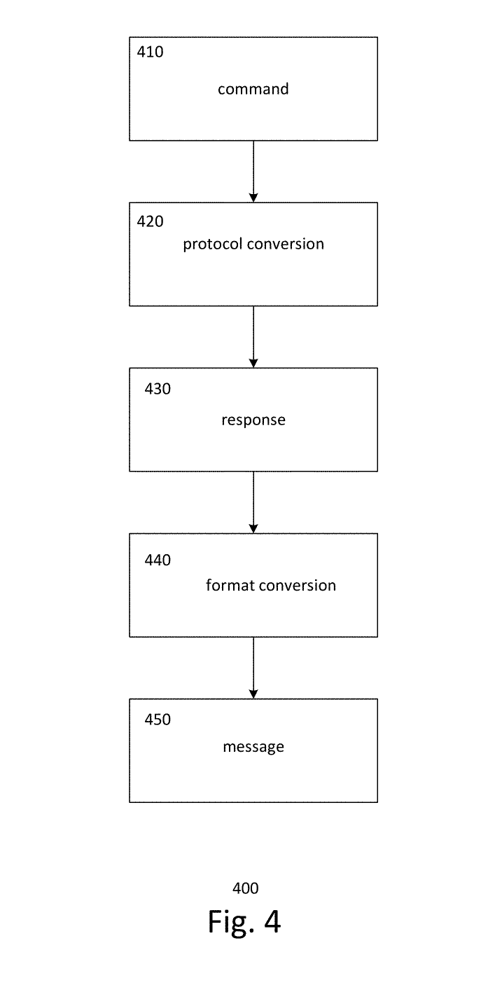

FIG. 4 shows an embodiment of data retrieval or collection flow 400 by a collector. The data collection flow is initiated everytime a collector collects data from the monitored device based on the configuration. For example, the flow is initiated at each polling interval. At step 410, a data retrieval command is issued. In one embodiment, the orderer component of the collector issues the data retrieval command. The command is converted to, for example, an appropriate protocol at step 420. In one embodiment, the command is converted to a protocol based on the configuration data in the configuration store component. The protocol conversion, in one embodiment, is performed by the protocol layer component.

The command is sent to the monitored device. For example, the command is sent to the monitored device as defined by the configuration of the collector. The response from the monitored device is received by the collector. In one embodiment, the collector receives the monitored data via the protocol layer. The protocol layer converts the response to raw data for pre-processing by the pre-processor unit at step 440. In one embodiment, the response is pre-processed by the message parser component of the pre-processor unit. For example, the response is converted into a format for communication with the cloud-based monitoring system. In one embodiment, the response is converted into a JSON message format. The JSON message may be referred to as a converted message. The converted message includes the name of each metric listed in the configuration and the associated monitored device. This facilitates routing the converted message by the message bus. The converted message is sent to the communication manager unit which sends it to the cloud-based monitoring system via the message bus.

In one embodiment, the response is also checked to see whether it is out-of-range based on the configuration. For example, the raw data is checked to determine whether it is out-of-range based on the configuration. In one embodiment, the raw data is checked by the message parser component prior to converting to the JSON message format. In the event that the raw data is out-of-range, an alarm message is generated at step 450. For example, an alarm message is generated by the message parser and sent to the events and alarms component. In one embodiment, the events and alarms component formats the alarm message into a JSOM message. The alarm message is sent to the cloud-based monitoring system via the communication manager unit and message bus.

As described, the data flow is performed by a collector at each initiation of data retrieval based on its configuration. Other collectors of the cloud-enabled system also perform data retrieval based on their configurations. As discussed, different collectors may have different configurations.

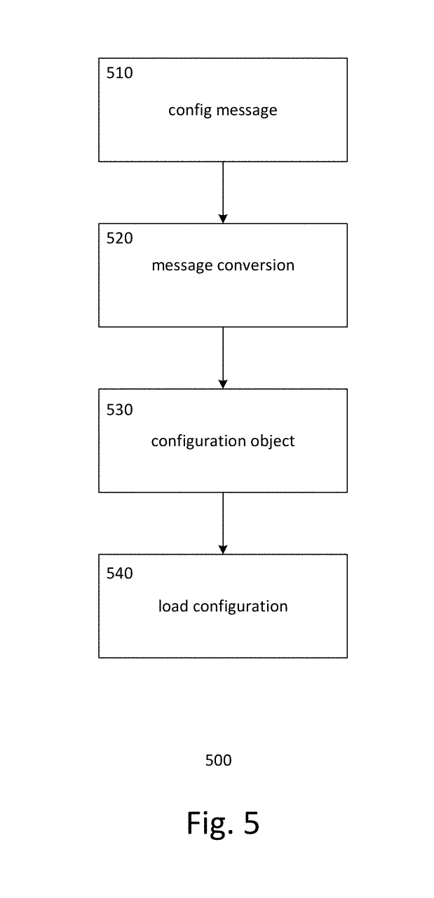

FIG. 5 shows an embodiment of a configuration flow 500. At step 510, a configuration message is received from the cloud-based monitoring system. For example, upon start-up, the cloud-enabled data collection system receives a configuration message. In other cases, the configuration message may be sent by the cloud-based monitoring system to change the configuration of a collector. The configuration message, for example, is received by the communication manager unit from the message bus.

At step 520, the configuration message is converted to an internal format of the cloud-enabled data collection system. In one embodiment, the configuration message is converted into an internal message object. For example, the communication manager unit converts the configuration message into the internal configuration message object. Other types of internal formats may also be useful. The internal configuration message object, in one embodiment, is forwarded to the configuration manager unit.

As discussed, the configuration message includes configuration data, including the device to be configured, performance metrics which will be monitored or collected from a monitored device, the performance baseline indicator, such as a threshold for alerts and alarms, and polling interval of the monitored data. Other types of configuration data may also be included.

Based on the configuration message, the configuration manager unit passes the configuration message to the collector manager unit at step 530. For example, the configuration manager unit may instruct the collector manager unit to instantiate a new collector to start monitoring a new device using a pre-determined protocol. The collector manager unit loads the configuration to the appropriate collector. In the case that the collector does not exist, a new collector is created. For example, in the case where collectors are software collectors, a new software collector is created. In the case that the collector is a hardware collector, a new collector may be added. For example, the cloud-enabled data collection system may inform the network administrator to add a new collector.

At step 540, the configuration object is loaded. In the case of start-up situation of the cloud-enabled data collection system, the configuration object is loaded into the collector. For example, the collector controller component loads the configuration into the configuration store component. In the case where, during an operation, a new configuration object is received to change the configuration of the collector, data collection is stopped and the new configuration is loaded. For example, the collector controller component stops data collection, loads the configuration into the configuration store component and restarts data collection based on the new configuration.

As discussed, the configuration is performed for all collectors at start-up of the cloud-based data collection system. For example, configuration messages are received for all collectors. Each of the collectors has its own configuration. During an operation, a new configuration message may be provided to change the monitoring behavior of a collector. The configuration message may also apply to more than one collector. For example, a configuration message unit may contain the configuration of multiple collectors.

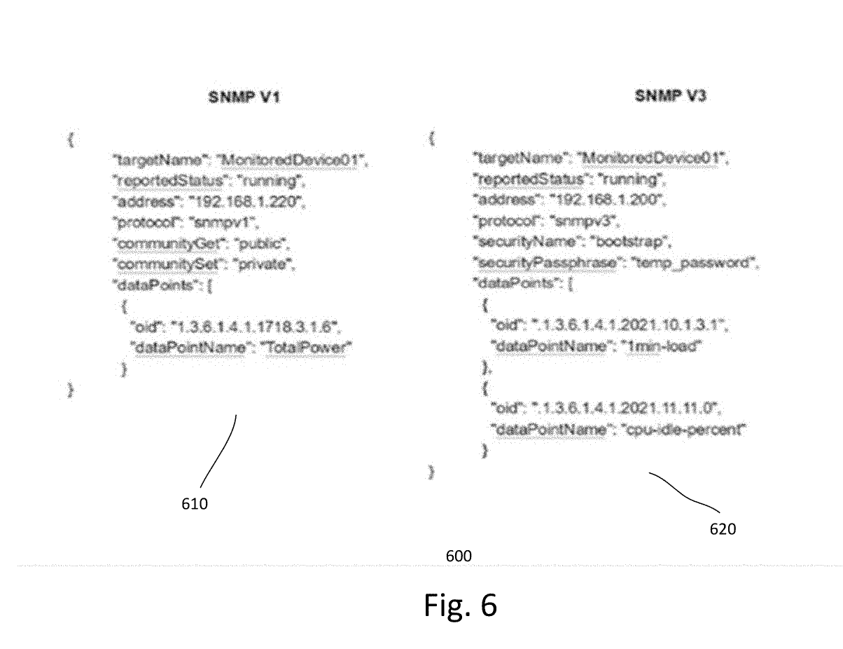

FIG. 6 illustrates exemplary configurations 600 for a collector. As shown, a first JSON representation 610 employs SNMP V1 protocol while a second JSON representation 620 employs SNMP V2 protocol. The JSON representations include metrics to be monitored in each monitored device. SNMP relies on the concept of the object identifier. In the examples shown, the configuration specifies the object identifier that will be monitored by the collector of the cloud-enabled data collection system as well as their names.

In one embodiment, communication between the cloud-enabled data collection system and cloud-based monitoring system is secured. As discussed, the communication manager unit and message bus serve as interfaces for communication between the cloud-enabled data collection system and cloud-based monitoring system. The communication may be secured by a Transport Layer Security protocol. Other types of security protocols may also be useful.

To initiate the communication flow, the communication manager unit may present its security certificate for authentication by the message bus. The communication flow may be initiated, for example, during start-up. The communication flow may also be initiated when the cloud-enabled monitoring system needs to reconnect to the message bus. For example, the communication flow may be initiated after network is reestablished from being down or after maintenance of the message bus. In one embodiment, the communication manager unit sends its X.509 security certificate to the message bus for authentication. Other types of security certificates may also be useful. Based on the identity of the security certificate, the message bus determines the configuration of the cloud-enabled data collection system. After the cloud-enabled data collection system has been authenticated and an encrypted communication path has been established, the communication manager unit and the message bus exchange messages using a compatible format. In one embodiment, the messages are exchanged using the JSON interchange format. Other types of formats may also be useful.

The present disclosure may be embodied in other specific forms without departing from the spirit or essential characteristics thereof. The foregoing embodiments, therefore, are to be considered in all respects illustrative rather than limiting the invention described herein. The scope of the disclosure is thus indicated by the appended claims, rather than by the foregoing description, and all changes that come within the meaning and range of equivalency of the claims are intended to be embraced therein.

1. A stateless cloud-enabled data collection system, the cloud-enabled data collection system comprises:
a communication manager unit, the communication manager unit is configured to manage communication between the cloud-enabled data collection system on a private network and a cloud-based monitoring system on a cloud;
a data collection unit, the data collection unit is configured to collect monitored data from monitored devices communicatively coupled to the private network; and
a pre-processor unit pre-processes the monitored data collected from the monitored devices, the pre-processor
formats the monitored data for sending to the cloud-based monitoring system by the communication manager unit, and
checks the monitored data to determine if the monitored data is out-of-range based on configuration of the data collection unit.

2. The stateless cloud-enabled data collection system of claim 1 wherein the private network comprises a TCP/IP network.

3. The stateless cloud-enabled data collection system of claim 1 wherein the communication manager unit serves as an interface for communication with the cloud-based monitoring system.

4. The stateless cloud-enabled data collection system of claim 1 wherein the communication manager unit, the data collection unit and the pre-processor unit form a data collection module of the cloud-enabled data collection system.

5. The stateless cloud-enabled data collection system of claim 1 wherein the data collection unit comprises:
a configuration manager unit, wherein the configuration manager unit is configured to receive configuration data from the cloud-based monitoring system; and
a collector manager unit comprising a plurality of n collectors, wherein the collectors are coupled to n monitored devices based on the configuration data from the configuration manager unit.

6. The stateless cloud-enabled data collection system of claim 5 wherein the collector manager unit loads the configuration data for the n collectors.

7. The stateless cloud-enabled data collection system of claim 5 wherein each of the n collectors comprises its own respective configuration data.

8. The stateless cloud-enabled data collection system of claim 5 wherein each collector comprises:
a collector controller component for controlling operation of the controller;
a configuration store component for storing configuration of the collector controller based on the configuration data from the configuration manager unit;
an orderer component for issuing a command to the monitored device communicatively coupled to the collector;
a protocol layer component, wherein the protocol layer component communicates with the monitored device;
a receiver unit for receiving a response from the monitored device based on the command;
a message parser, wherein the message parser is configured to pre-process the response from the monitored device; and
an events and alerts component, wherein the events and alerts component is configured to generate an alarm message when the response is out-of-range based on the configuration data in the configuration store component.

9. The stateless cloud-enabled data collection system of claim 5 wherein each collector serves as a command unit for issuing commands to the monitored device which is communicatively coupled thereto.

10. The stateless cloud-enabled data collection system of claim 1 communicates with the monitored devices using SNMP, IPMI, Modbus or a combination thereof.

11. The stateless cloud-enabled data collection system of claim 1 communicates with the cloud-based monitoring system through a message bus on the cloud.

12. A method for monitoring monitored devices coupled to a network comprising:
configuring a cloud-enabled data collection system coupled to the network, wherein the cloud-enabled data collection system collects monitored data from the monitored devices coupled to the network based on configuration of the cloud-enabled data collection system; and
pre-processing the monitored data, wherein the pre-processing comprises,
checking the monitored data to determine if it is out-of-range based on the configruation of the cloud-enabled data collection system,
generating an alarm if the monitored data is out-of-range for sending to a cloud-based monitoring system on a cloud by a communication manager unit of the cloud-enabled data collection system to indicate that the monitored data is out-of-range, and
formatting the monitored data for sending to the cloud-based monitoring system by the communication manager unit of the cloud-enabled data collection system.

13. The method of claim 12 wherein the network comprises a TCP/IP network.

14. The method of claim 12 wherein the communication manager unit serves as an interface for communication with the cloud-based monitoring system.

15. The method of claim 12 comprises:
configuring a configuration manager unit to receive configuration data from the cloud-based monitoring system; and
loading the configuration data for a plurality of n collectors with a collector manager unit, wherein the n collectors are coupled to n monitored devices based on the configuration data from the configuration manager unit.

16. The method of claim 15 wherein each of the n collectors comprises its own respective configuration data.

17. The method of claim 15 wherein each collector serves as a command unit for issuing commands to the monitored device which is communicatively coupled thereto.

18. The method of claim 12 wherein the cloud-enabled data collection system communicates with the monitored devices using SNMP, IPMI, Modbus r a combination thereof.

19. The method of claim 12 wherein the cloud-enabled data collection system communicates with the cloud-based monitoring system through a message bus on the cloud.

20. A computer-implemented method for monitoring monitored devices coupled to a network comprising:
configuring a cloud-enabled data collection system coupled to the network, wherein the cloud-enabled data collection system collects monitored data from the monitored devices coupled to the network based on configuration of the cloud-enabled data collection system; and
pre-processing the monitored data, wherein pre-processing comprises,
checking the monitored data to determine if it is out-of-range based on the configruation of the cloud-enabled data collection system,
generating an alarm if the monitored data is out-of-range for sending to a cloud-based monitoring system on a cloud by a communication manager unit of the cloud-enabled data collection system to indicate that the monitored data is out-of-range, and
formatting the monitored data for sending to the cloud-based monitoring system by the communication manager unit of the cloud-enabled data collection system.
